(19) United States
(12) Patent Application Publication
(10) Pub. No.: US 2008/0320263 A1
(43) Pub. Date: Dec. 25, 2008

(54) METHOD, SYSTEM, AND APPARATUS FOR ENCRYPTING, INTEGRITY, AND ANTI-REPLAY PROTECTING DATA IN NON-VOLATILE MEMORY IN A FAULT TOLERANT MANNER

(76) Inventors: Daniel Nemiroff, Folsom, CA (US); Howard Hebert, Phoenix, AZ (US)

Correspondence Address: INTEL CORPORATION;c/o INTELLEVATE, LLC, P.O. BOX 52050, MINNEAPOLIS, MN, 55402, US

(21) Appl. No.: 11/765,853

(22) Filed: Jun. 20, 2007

(51) Int. Cl. G06F 12/14

(52) U.S. Cl. 711/164; 711/E12.094

(57) ABSTRACT

According to some embodiments, a method for providing encryption, integrity, and anti-replay protection of data in a fault tolerant manner is disclosed. A data blob and an anti-replay table blob are copied to a temporary storage region in a non-volatile memory. In an atomic operation, a status indicator is set and a monotonic counter is incremented after the data blob and the anti-replay table blob are copied to the temporary storage region. If a fault occurs while the status indicator is set, the data blob and the anti-replay table blob may be recovered from the temporary storage region.

### BACKGROUND

In computer processes, security of data remains an issue. Data may be protected using one or more of confidentiality protection, integrity protection, and anti-replay protection. Confidentiality protection may be provided by data encryption, so that an unauthorized user may not be able to read the encrypted data. Integrity protection may be used to detect whether the data has been modified or otherwise tampered with. Anti-replay protection may be used to prevent a data message from being sent to the recipient multiple times.

### BRIEF DESCRIPTION OF THE DRAWINGS

A better understanding of embodiments of the present invention can be obtained from the following detailed description in conjunction with the following drawings, in which:

FIG. 1 is a block diagram of a system according to some embodiments.

FIG. 2 is a flow diagram illustrating a method for confidentiality, integrity, and anti-replay protecting data stored in a non-volatile memory according to some embodiments.

FIG. 3 is a block diagram illustrating creation of a data blob according to some embodiments.

FIG. 4 is a block diagram illustrating creation of an anti-replay table blob according to some embodiments.

FIG. 5 is a block diagram illustrating creation of a data blob and an anti-replay table blob in a non-volatile memory in a fault and power-loss tolerant manner.

FIG. 6 is a flow diagram illustrating a method for storing a data blob and an anti-replay table blob in a non-volatile memory in a fault and power-loss tolerant manner according to some embodiments.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment,” “an embodiment,” “example embodiment,” “various embodiments,” etc., indicate that the embodiments) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. Some embodiments may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

A “binary large object”, also known as a “blob”, is a collection of binary data stored as a single entity in a volatile or non-volatile media. A blob may be any data object, including, but not limited to executable files, images, etc. Blobs can be secured with confidentiality, integrity and/or anti-replay protection.

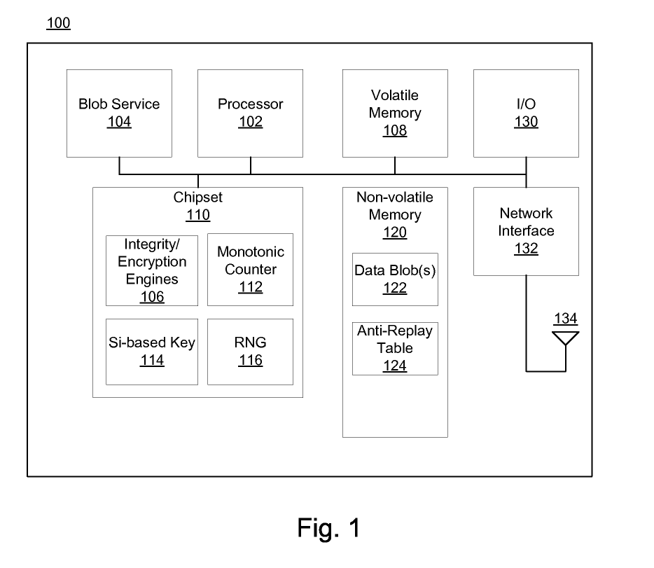

FIG. 1 is a block diagram of a system 100 according to some embodiments. The system may include one or more processors 102, which may be single core or multi-core processors. Coupled to the processor 102 is a chipset 110. The chipset 110 may include, for example, an input/output controller hub (ICH) and/or a memory controller hub (MCH). In some embodiments, the chipset and the processor may be integrated onto a single die, or contained on multiple die in a single package. In other embodiments, the chipset and processor may be in separate packages.

Also coupled to the processor 102 may be a volatile memory device 108, such as a dynamic random access memory (DRAM) or other volatile memory, and a non-volatile memory device 120, such as, but not limited to a flash memory device or hard disk drive (HDD). The non-volatile memory device 120 may be used to store one or more data blobs 122 and an anti-replay table 124 associated with the one or more data blobs 122. In some embodiments, the anti-replay table may itself be a protected blob, and may include a monotonic counter value and header for each data blob 122.

They system may also include input/output (I/O) devices 130, and a wired or wireless network interface 132. A wireless network interface may include an antenna, 134.

Blob service application 104 is used to create blobs that are confidentiality, integrity and/or anti-replay protected. The blob service 104 may be a firmware or software based application, and may be executed by the processor 102.

The chipset 110 may include a silicon based symmetric key 114. The key may be created during the silicon manufacturing process by randomly blowing hardware fuses in the die. The number of fuses used determines the level of security. The more fuses used to generate the silicon-based key, the stronger the level of security for the key. In some embodiments, 128 fuses may be used. Variable sized keys may be generated from the fuses depending on how subsequent keys are derived. For example, a SHA-256 (secure hash algorithm) will generate a 256-bit key that can be used in AES-256 (advanced encryption standard) confidentiality operations.

The chipset 110 may further include an integrity/HMAC (keyed-hash message authentication code) engine and an encryption engine 106. The integrity and encryption engines 106 may be firmware, hardware, or software based. The integrity and encryption engines are used to provide confidentiality and integrity protection for a blob.

The chipset 110 may further include a monotonic counter 112 and a random number generator 116. The monotonic counter may retain power in all system power states, and may be used to associate a data blob 122 with an entry in the anti-replay table 124. The random number generator 116 may generate a random number that is appended to the monotonic counter value. A random number may be generated when the monotonic counter 112 is reset, and then is appended to the monotonic counter value. The random number allows the blob service 104 to detect when the monotonic counter 112 has been reset.

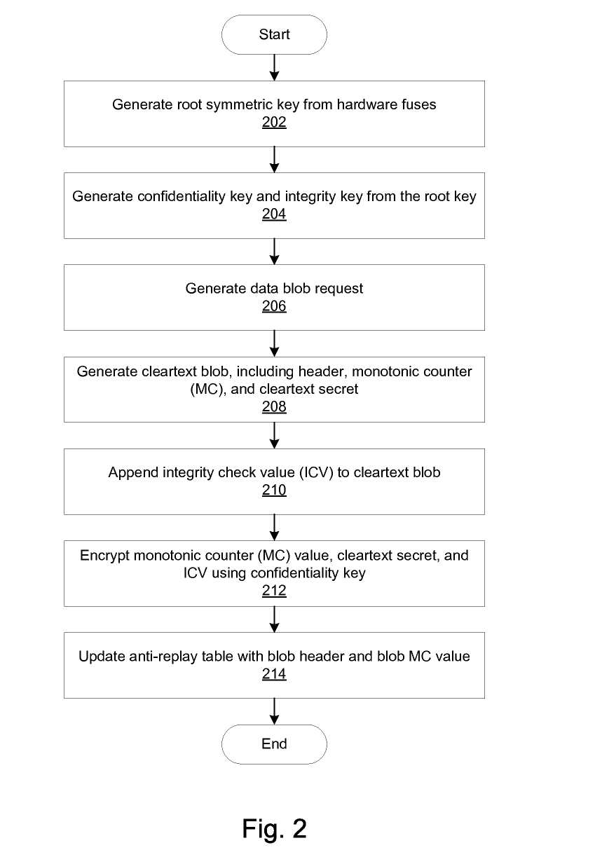

FIG. 2 is a flow diagram illustrating a method for confidentiality, integrity, and anti-replay protecting a data blob according to some embodiments.

On system power on, secure firmware may read the silicon based symmetric key, which in some embodiments may be hardware fuses. A root symmetric key may be generated from the silicon based symmetric key, as shown in block 202. In some embodiments, secure firmware may derive the root symmetric key by using a pass-phrase and the silicon based symmetric key as inputs to an algorithm, such as but not limited to, a SHA-256 algorithm. The output of the algorithm may be the root symmetric key.

Other keys, such as a confidentiality key and/or an integrity key, may be derived from the root symmetric key, as shown in block 204. In some embodiments, the confidentiality key may be used as an input to an AES-CTR (Advanced Encryption Standard-Counter) mode to encrypt the data to be stored in a blob. In some embodiments, the integrity key may be used as an input to an HMAC to generate an integrity check value (ICV).

A request may be made to generate a data blob, as shown in block 206. In some embodiments, the request may be made via a public API (application programming interface). The request may include the cleartext to be included in the data blob as well as the type(s) of protection required (e.g., integrity, confidentiality, and/or anti-replay protection). The request may also specify particular integrity and/or confidentiality algorithms to be used.

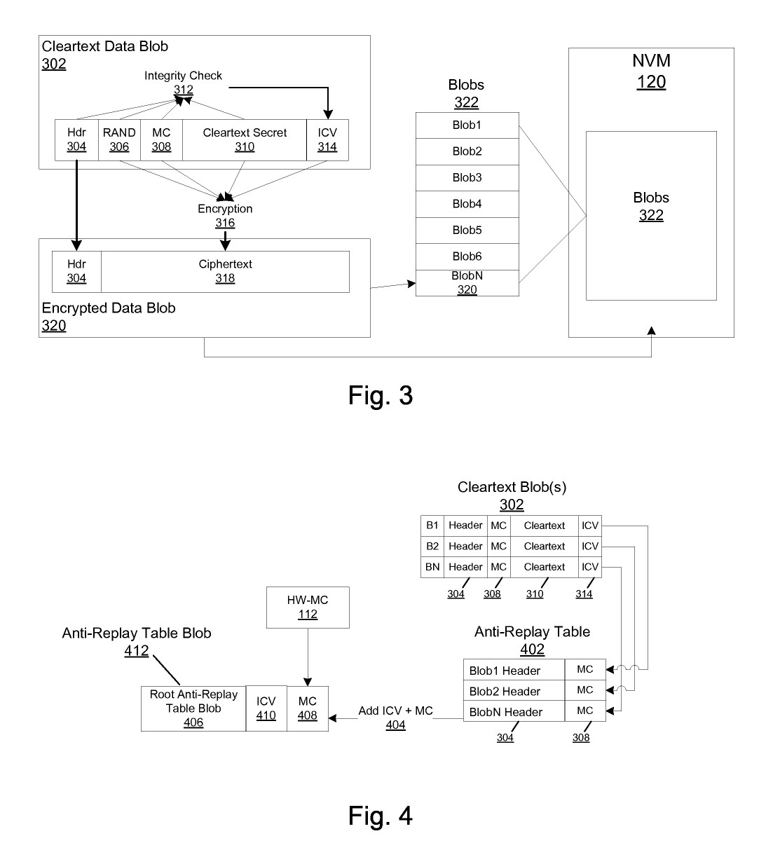

After a request to generate a data blob is received, the blob service may create the blob in cleartext, as shown in block 208. FIG. 3 is a block diagram illustrating the creation of a data blob for a cleartext secret 310. In creating the cleartext data blob 302, the blob service creates a header 304 to describe the blob. The header 304 may contain information such as the type of protection on the blob, the blob size, or other non-secret information. Because the header 304 does not contain any secrets, it may remain as cleartext, and may not be encrypted.

The blob service also appends the monotonic counter value 308 and the associated random number 306 to the header 304, and also appends the cleartext secret 310 to the header.

Referring back to FIG. 2, an integrity check value is appended to the cleartext blob, as shown in block 210. As shown in FIG. 3, the integrity check value (ICV) 314 is created using an integrity check algorithm 312. The inputs to the integrity check algorithm include the cleartext header 304, the monotonic counter value 308 and associated random number 306, and the cleartext secret 310. The integrity check value 314 is appended to the cleartext data blob 302.

After the integrity check value has been appended to the cleartext data blob, the monotonic counter value and associated random number, the cleartext secret, and the integrity check value are encrypted using a confidentiality key, as shown in block 212 of FIG. 2. FIG. 3 illustrates the encrypted data blob 320 created after the monotonic counter value 308 and associated random number 306, the cleartext secret 310, and the integrity check value 314 have been encrypted 316 using the derived confidentiality key. They encrypted data blob includes blob header 304 and ciphertext 318. The blob header 304 is not encrypted since it must be read before decryption occurs, and it contains no secrets. The encrypted data blob 320 may be one of a number of blobs 322 stored in a nonvolatile memory 120.

Referring again to FIG. 2, whenever a data blob is created or modified, the anti-replay table will be updated with the blob header and the blob monotonic counter value as shown in block 214. In some embodiments, the anti-replay table may be updated before the monotonic counter value for the cleartext data blob is encrypted.

FIG. 4 is a block diagram illustrating the updating of an anti-replay table. The anti-replay table 402 contains a table of monotonic counter values 308 and headers 304 that are associated with each blob 302. The anti-replay table 402 may be stored in nonvolatile memory as an integrity and anti-replay protected blob 412. Thus, when a blob is created or modified, the blob's header 304 and monotonic counter value 308 are added to the anti-replay table 402. An integrity check value 408 and monotonic counter value 410 from the hardware monotonic counter 112 are appended to the root anti-replay table blob 406. When a blob is modified, both the monotonic counter value in the blob 308 and the monotonic counter value in the table 408 are incremented. Thus, the anti-replay table blob 412 may be both integrity and anti-replay protected.

The creation of data blobs and updating of the associated anti-replay table blob 412 is a non-atomic operation involving multiple writes to a nonvolatile memory. If the operation is not fault and power loss tolerant, data corruption may be possible. For example, if the most recently modified data blob becomes out of synch with the anti-replay table, a replay attack may be mistakenly detected on the next blob access, resulting in blob invalidation and data loss.

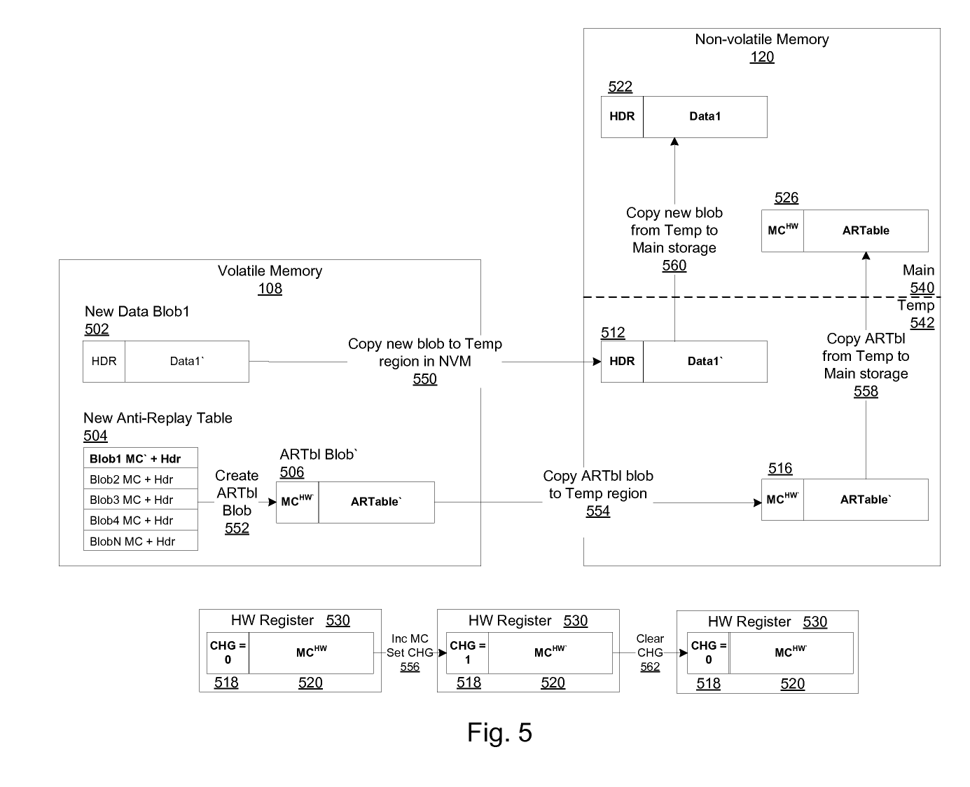

FIG. 5 is a block diagram illustrating creation of a data blob and an anti-replay table blob in a non-volatile memory in a fault and power-loss tolerant manner. When the blob service creates a new data blob 502, it is initially created in volatile memory 108, such as DRAM. The data blob is then copied 550 to a temporary storage region 542 in a nonvolatile memory 120, to create a temporary copy of the data blob 512. Similarly, when the anti-replay table 504 is updated, an anti-replay table blob 506 is created 552 in volatile memory 108. The anti-replay table blob 506 is then copied 554 to the temporary storage region 542 in the nonvolatile memory 120, to create a temporary copy of the anti-replay table blob 516.

After the data blob has been created and copied to temporary storage and the anti-replay table blob has been updated and copied to temporary storage, the monotonic counter value 112 is incremented and a monotonic counter changing status indicator 518 (e.g., status bit CHG) is set 556. In some embodiments, updates to the status indicator 518 occur automatically with updates to the monotonic counter 520 in an atomic operation. An atomic operation may be one that cannot be interrupted, such as, for example, an operation executed with a single microprocessor instruction. In execution, an atomic operation is performed entirely or not at all.

In some embodiments, the status indicator 518 and the monotonic counter 520 may be implemented in a single hardware register 530. In some embodiments, setting the status indicator 518 and incrementing the monotonic counter 520 is done by executing a single microprocessor instruction.

When the status indicator 518 is set, this indicates that a valid copy of the newly created data blob 512 and anti-replay table blob 516 exist in a temporary region 542 in the nonvolatile memory 120. Next, the anti-replay table blob 516 is copied 558 from the temporary storage region 542 to a main storage region 540 in the nonvolatile memory 120. The data blob 512 is also copied 560 from the temporary storage region 542 to the main storage region 540 in the nonvolatile memory 120. After the data blob 522 and the anti-replay table 526 are in the main storage region of the non-volatile memory, the status indicator is cleared 562 to indicate that the data blob and the anti-replay table blob in the temporary storage region 542 are no longer valid, and that the data blob and the anti-replay table blob in the main storage region 540 are valid

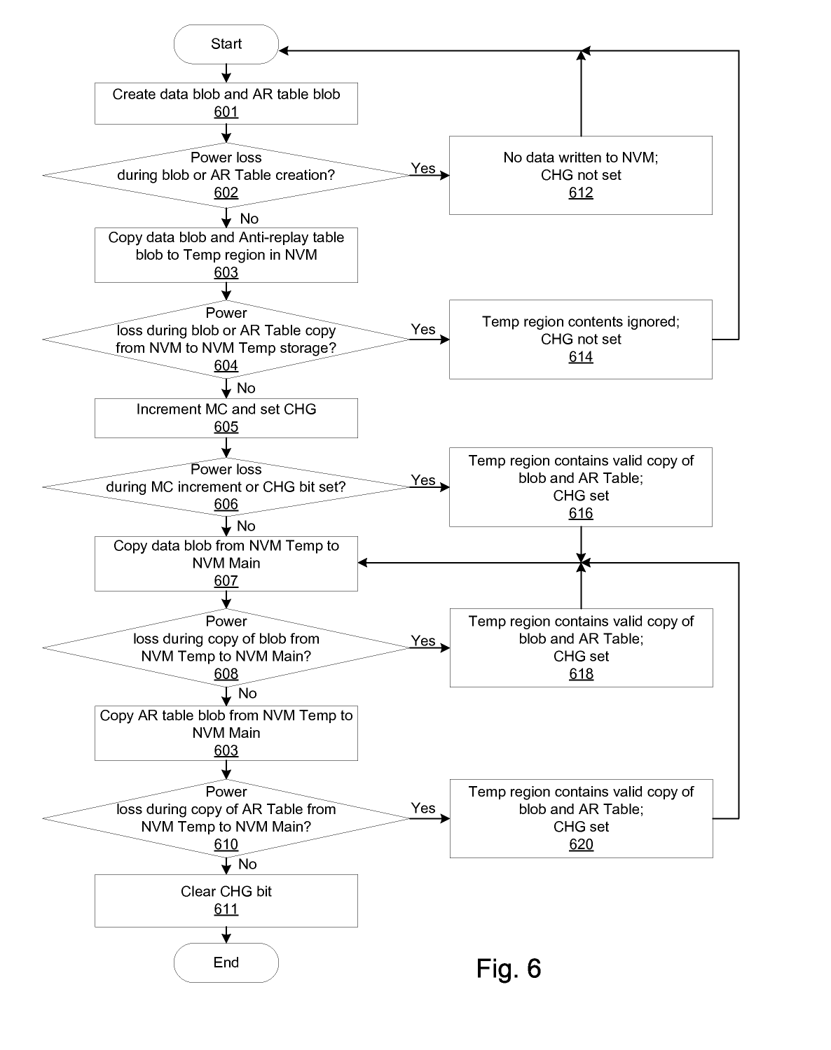

FIG. 6 is a flow diagram illustrating a method for storing a data blob and an anti-replay table blob in a non-volatile memory in a fault and power-loss tolerant manner according to some embodiments. As described above, first a data blob is created or modified and the anti-replay table is updated 601. If power loss or a fault occurs during data blob or anti-replay table blob creation 602, all data exists only in volatile memory and will be lost. No data has been written to the non-volatile memory, and the CHG status bit has not been set 612. On reboot, the blob service will take no action because the CHG status bit is not set.

The data blob and anti-replay table are then copied to a temporary storage region 603. If power loss or a fault occurs during the copy of either the data blob or anti-replay table to the temporary storage region and the copy of both the data blob and the anti-replay table is unsuccessful 604, the contents of the temporary storage region will be ignored, and the CHG status bit will not be set 614. On reboot, the blob service will take no action because the CHG status bit is not set.

After the data blob and anti-replay table are copied to the temporary storage region, the monotonic counter will be incremented and the CHG status bit will be set in an atomic operation 605. If a power loss or fault occurs during the monotonic counter increment and setting of the CHG status bit 606, on the next reboot, the CHG status bit will be set 616 and the blob service will recognize that the temporary storage region contains a valid blob and anti-replay table 616. Thus, the blob service can continue to execute from block 607 upon recovery from the power loss or fault, recovering the data blob and the anti-replay table blob from the temporary storage region.

When the monotonic counter has been incremented and the CHG status bit has been set, the data blob will be copied from the temporary storage area to the data blob destination (main storage area) in nonvolatile memory 607. If a power loss or fault occurs during the copy of the data blob from the temporary storage area to the main storage area 608, on the next reboot, the CHG status bit will be set 616 and the blob service will recognize that the temporary storage region contains a valid blob and anti-replay table 616. Thus, the blob service can continue to execute from block 607 upon recovery from the power loss or fault.

Similarly, the anti-replay table blob will be copied from the temporary storage area to the main storage area in the nonvolatile memory 609. If a power loss or fault occurs during the copy of the anti-replay table blob from the temporary storage area to the main storage area 610, on the next reboot, the CHG status bit will be set 616 and the blob service will recognize that the temporary storage region contains a valid blob and anti-replay table 616. Thus, the blob service can continue to execute from block 607 upon recovery from the power loss or fault, repeating blocks 607-609.

After both the anti-replay table and the data blob have been successfully copied to the main storage area, the CHG status bit will be cleared 611. The blob creation request has been completed in a fault tolerant manner.

Thus, a fault tolerant method for encrypting, integrity, and anti-replay protecting data in nonvolatile memory is disclosed in various embodiments. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method, comprising:
copying a data blob and an anti-replay table blob to a temporary storage region in an non-volatile memory; and
setting a status indicator and incrementing a monotonic counter in an atomic operation after copying the data blob and the anti-replay table blob to the temporary storage region.

2. The method of claim 1, further comprising copying the data blob and the anti-replay table blob from the temporary storage region to a main storage region in the non-volatile memory.

3. The method of claim 2, further comprising clearing the status indicator after copying the data blob and the anti-replay table blob to the main storage region.

4. The method of claim 1, further comprising determining after a reboot that the status indicator is set and subsequently copying the data blob and the anti-replay table blob from the temporary storage region to a main storage region in the non-volatile memory.

5. The method of claim 1, further comprising determining after a reboot that the status indicator is not set and subsequently taking no further action related to the data blob and the anti-replay table.

6. The method of claim 1, further comprising generating the data blob, wherein the data blob includes a header, a monotonic counter value, a random value, a cleartext secret, and an integrity check value, and updating the anti-replay table blob with the header and monotonic counter value for the data blob.

7. The method of claim 6, wherein the monotonic counter value, the random value, the cleartext secret, and the integrity check value of the data blob are encrypted using a confidentiality key derived from a plurality of hardware fuses.

8. The method of claim 1, wherein the status indicator and the monotonic counter are in a single hardware register.

9. The method of claim 1, wherein the setting of the status indicator and the incrementing of the monotonic counter comprises executing a single microprocessor instruction.

10. The method of claim 1, wherein the non-volatile memory is one of a flash memory and a hard disk drive.

11. A system comprising:
a processor to run a blob service;
a chipset coupled to the processor, the chipset including a monotonic counter; and
a non-volatile memory device coupled to the processor, wherein the blob service is to generate a data blob and an anti-replay table blob to be written to the nonvolatile memory device in a fault tolerant manner, wherein the data blob includes a header and a monotonic counter value from the monotonic counter and wherein the anti-replay table blob includes the header and the monotonic counter value of the data blob.

12. The system of claim 11, wherein the monotonic counter is part of a register, and wherein the register further includes a status indicator.

13. The system of claim 12, wherein the status indicator is to indicate whether the data blob and the anti-replay table blob have been successfully written to a temporary storage area within the non-volatile memory device.

14. The system of claim 12, wherein the data blob is protected using confidentiality, integrity, and anti-replay protection.

15. The system of claim 14, wherein the anti-replay table blob is protected using integrity and anti-replay protection.

16. The system of claim 11, wherein the chipset further includes an integrity engine, an encryption engine, a silicon-based key, and a random number generator.

17. An article of manufacture comprising a machine-accessible medium including data that, when accessed by a machine cause the machine to perform operations comprising:
copying a data blob and an anti-replay table blob from a volatile memory to a temporary storage region in an non-volatile memory; and
setting a status indicator and incrementing a monotonic counter in an atomic operation after copying the data blob and the anti-replay table blob to the temporary storage region.

18. The article of manufacture of claim 17, wherein the machine accessible medium further includes data that causes the machine to perform operations comprising copying the data blob and the anti-replay table blob from the temporary storage region to a main storage region in the non-volatile memory.

19. The article of manufacture of claim 18, wherein the machine accessible medium further includes data that causes the machine to perform operations comprising clearing the status indicator after copying the data blob and the anti-replay table blob to the main storage region.

20. The article of manufacture of claim 17, wherein the machine accessible medium further includes data that causes the machine to perform operations comprising determining after a reboot that the status indicator is set and subsequently copying the data blob and the anti-replay table blob from the temporary storage region to a main storage region in the non-volatile memory.

21. The article of manufacture of claim 17, wherein the machine accessible medium further includes data that causes the machine to perform operations comprising determining after a reboot that the status indicator is not set and subsequently taking no further action related to the data blob and the anti-replay table.

22. The article of manufacture of claim 17, wherein the machine accessible medium further includes data that causes the machine to perform operations comprising generating the data blob, wherein the data blob includes a header, a monotonic counter value, a random value, a cleartext secret, and an integrity check value, and updating the anti-replay table blob with the header and monotonic counter value for the data blob.

23. The article of manufacture of claim 22, wherein the monotonic counter value, the random value, the cleartext secret, and the integrity check value of the data blob are encrypted using a confidentiality key derived from a plurality of hardware fuses.

24. The article of manufacture of claim 17, wherein the status indicator and the monotonic counter are in a single hardware register.

25. The article of manufacture of claim 17, wherein the setting of the status indicator and the incrementing of the monotonic counter comprises executing a single microprocessor instruction.

26. A method, comprising:
generating a data blob, wherein the data blob includes a header and a monotonic counter value from a hardware monotonic counter;
updating an anti-replay table blob with the header and the monotonic counter value for the data blob and associating the anti-replay table blob with the monotonic counter value; and
incrementing the hardware monotonic counter and setting a status indicator when the data blob and the anti-replay table blob are stored in a temporary storage region in a non-volatile memory.

27. The method of claim 26, wherein the incrementing the hardware monotonic counter and the setting the status indicator occur in a monotonic operation.

28. The method of claim 26, further comprising clearing the status indicator when the data blob and the anti-replay table blob are stored in a main storage region in a non-volatile memory.

29. The method of claim 26, further comprising after a reboot determining if the status indicator is set, and if so, copying the data blob and the anti-replay table blob from the temporary storage region in the non-volatile memory to a main storage region in the non-volatile memory.
